(19) United States
(12) Patent Application Publication
(10) Pub. No.: US 2002/0129777 A1
(43) Pub. Date: Sep. 19, 2002

(54) Two stroke internal combustion engine

(76) Inventors: Vladimir B. Kozulin, Dover, NH (US); Boris P. Chopovski, Dover, NH (US); Nikolai V. Kozulin, Dover, NH (US)

Correspondence Address: Vladimir B. Kozulin, 8 New Bellamy Lane, Dover, NH, 03820, US

(21) Appl. No.: 10/113,737

(22) Filed: Apr. 1, 2002

Related U.S. Application Data
(62) Division of application No. 09/339,320, filed on Jun. 23, 1999.

(30) Foreign Application Priority Data
Jun. 22, 1998 (RU) 98111885/06

(51) Int. Cl. F02B 75/18

(52) U.S. Cl. 123/52.5

(57) ABSTRACT

A two stroke internal combustion engine, comprising one or more power cylinders with intake and exhaust ports and a source of scavenging of the power cylinders, with improvements, including use of double-sided cylinders with upper and lower cavities used as power or pumping cavities connected to each other in different combinations; multi-bank engine structures with cavities of the cylinders in the first and second bank used as power or pumping cavities, connected to each other in different combinations.

### CROSS-REFERENCE TO RELATED PATENTS AND APPLICATIONS

Two Stroke Internal Combustion Engine. Patent of Russian Federation No. 2143077, Int. Cl. F02 B 33/00, registered Dec. 20, 1999, published in 1999, Bul. No. 35, priority date Jun. 22, 1998, application No. 98111885/06.

### REFERENCES CITED

1. Two Stroke Internal Combustion Engine. RU Patent No. 2063524, Int. Cl. F02 B 33/22, published in 1996, Bul. No. 19.

2. Two Stroke Internal Combustion Engine. U.S. Pat. No. 2,522,649, US Cl. 123-70, 1950.

3. Radial Two Stroke Internal Combustion Engine with Piston Scavenging Pumps. SU Patent No. 54112, Int. Cl. F02 B 33/22, 75-22, 1939.

### INFORMATION SOURCES, TAKEN INTO CONSIDERATION

1. RU Patent No. 2063524 Cl, 10.07.96

2. U.S. Pat. No. 2,522,649 A, 19.09.50

3. SU Patent No. 54112 A, 28.02.39

4. SU Patent No. 2472 A, 31.03.27

5. U.S. Pat. No. 3,880,126 A, 29.04.75

6. U.S. Pat. No. 5,265,564 A, 30.11.93

7. GB Patent No. 994371 A, 07.11.61

### BACKGROUND OF THE INVENTION

This invention relates to further development of two stroke internal combustion engines (from hereinafter referred to as ‘TSICE’), which have one or more power cylinders with intake and exhaust ports, and a source of scavenging of the power cylinders.

Some terms and abbreviations used in the following description of previous art and present invention are defined below.

Pistons of TSICE move reciprocally within two limits, conventionally named as ‘top dead center’ and ‘bottom dead center’. From hereinafter top dead center is referred to as ‘TDC’ and bottom dead center as ‘BDC’.

Cavity of a cylinder, which is a space within the walls of the cylinder limited by a face of a piston, from hereinafter is referred to as ‘cavity’.

In a double-sided cylinder, a piston has two faces, front and rear, which form two cavities within the walls of the cylinder on the opposite sides of the piston. In further description, due to the upright position of the cylinders on the drawings, the said cavities are referred to as ‘upper cavity’ and ‘lower cavity’.

The main problems, known as deficiencies of TSICE, are the partial mixing of burned gases with the fresh air-fuel mixture, and the loss of some fresh air-fuel mixture through the exhaust ports at the time of scavenging.

As long as improvements can be achieved, reducing these problems, there is a chance to increase power per liter of displacement.

The so-called direct-flow scavenging/charging of the power cylinders has to be organized, when fresh air-fuel mixture fills up the cavity of the power cylinder starting from the intake port towards the exhaust port, so that burned gases always remain in the way of the air-fuel mixture to the exhaust port with minimum mixing.

One of the ways to achieve the direct-flow scavenging/charging is to have two power cylinders, connected to each other with a common combustion chamber, where one of the cylinders has the intake port, and another has the exhaust port, as it is in RU Patent No. 2,063,524. Scavenging/charging starts in one cylinder and ends in the other, most importantly, cleaning the area of combustion chamber of burned gases and providing unidirectional displacement of burned gases with fresh air-fuel mixture. RU Patent No. 2,063,524 uses a pumping cylinder as a source of scavenging/charging of power cylinders.

TSICE, according to U.S. Pat. No. 2,522,649, comprises power and pumping cylinders with intake and exhaust ports, where the exhaust port of the pumping cylinder is connected to the intake port of the power cylinder by a channel.

TSICE, according to RU Patent No. 2,063,524, comprises the first power cylinder with an intake port, connected to a pumping cylinder, and the second power cylinder with an exhaust port, said cylinders having a common combustion chamber and pistons connected each to its own crank, with the crank of the second piston having advanced crank angle against the crank of the first piston, enabling advanced opening and closing of the exhaust port in relation to the intake port.

A common drawback of the above named patents is the use of an additional cylinder, piston and crank solely for the purpose of scavenging/charging of another cylinder, which increases the size and weight of the engine and reduces power per liter of displacement.

According to the totality of distinctive characteristics, the engine construction of U.S. Pat. No. 2,522,649 is taken as the closest prototype of present invention.

Multi-bank structures of TSICE, as in the SU Patent No. 54112, are also considered.

### BRIEF SUMMARY OF THE INVENTION

Presented is TSICE with object to increase power per liter of displacement, which is achieved by use of double-sided cylinders with upper and lower cavities used as power or pumping cavities, connected to each other in different combinations, and use of multi-bank engine structure, reducing the number of cranks and pistons and size and weight of the engine.

### DRAWING FIGURES

FIG. 13 shows single-row double-bank TSICE comprising power cylinder in the first bank and double-sided cylinder in the second bank with pumping cavity, connected to a supercharger.

FIGS. 15A, 15B show double-row double-bank TSICE comprising two power cylinders in the first bank and two double-sided cylinders in the second bank with pumping cavities, connected to a supercharger, and piston cranks having angular deviation 180° against each other.

FIGS. 16A, 16B show double-row double-bank TSICE comprising two pumping cylinders in the first bank, connected to a supercharger, and two double-sided cylinders in the second bank with piston cranks having angular deviation 180° against each other.

### REFERENCE NUMERALS IN DRAWINGS

1 First cylinder of the first bank

2 Second cylinder of the first bank

5 First cylinder of the second bank

6 Second cylinder of the second bank

9 Piston of cylinder 1

10 Piston of cylinder 2

13 Piston of cylinder 5

14 Piston of cylinder 6

17 Upper cavity of cylinder 1

19 Upper cavity of cylinder 2

25 Upper cavity of cylinder 5

26 Lower cavity of cylinder 5

27 Upper cavity of cylinder 6

28 Lower cavity of cylinder 6

33 Intake port of cavity 17

35 Intake port of cavity 19

41 Intake port of cavity 25

42 Intake port of cavity 26

43 Intake port of cavity 27

44 Intake port of cavity 28

49 Exhaust port of cavity 17

51 Exhaust port of cavity 19

57 Exhaust port of cavity 25

58 Exhaust port of cavity 26

59 Exhaust port of cavity 27

60 Exhaust port of cavity 28

69 Transverse partition

70 Crank of piston 9

71 Crank of piston 10

74 Piston rod

76 Connecting rod

77 Crank-and-connecting-rod assembly

78 Oil-filled crankcase

79 Spark plug

80 High-pressure direct fuel injector

91 Supercharger

92 Engine intake manifold

98 Self-acting suction valve

100 Fuel pipeline

101 Low-pressure external fuel injector

103 Channel, connecting cavities 17 and 25

104 Channel, connecting cavities 17 and 26

105 Channel, connecting cavities 17 and 28

109 Channel, connecting cavities 19 and 26

111 Channel, connecting cavities 19 and 28

113 Channel, connecting cavities 25 and 28

114 Channel, connecting cavities 25 and 26

115 Channel, connecting cavities 26 and 27

116 Channel, connecting cavities 27 and 28

### DETAILED DESCRIPTION OF THE INVENTION

Present invention is applicable to the following three types of TSICE:

1) spark ignited (e. g. gasoline, propane) engine with an external mixing of air and fuel in the intake manifold and use of air-fuel mixture for scavenging of power cylinders;

2) spark ignited (e.g. gasoline) engine with scavenging of power cylinders with pure air and direct fuel injection into the power cylinders at the beginning of compression stroke after their ports are already closed;

3) self-ignited (diesel) engine with scavenging of power cylinders with pure air and direct fuel injection into the power cylinders at the end of compression stroke.

In TSICE of second and third types cylinders are scavenged/charged with pure air, having fuel injected directly into the cavity of power cylinder. In these engines low-pressure fuel injector 101 in the engine intake manifold is not present. Instead, in the second type of spark-ignited engine low-pressure direct fuel injector 99 installed in the power cylinder is used together with a spark plug 79. In self-ignited TSICE of the third type spark plug 79 is replaced with a high-pressure direct fuel injector 80. The direct injection of fuel into the power cylinders after scavenging is complete and ports of the power cylinders are closed, eliminates fuel loss and mixing of a fresh charge with burned gases.

Drawings and descriptions are made as for the first type of TSICE.

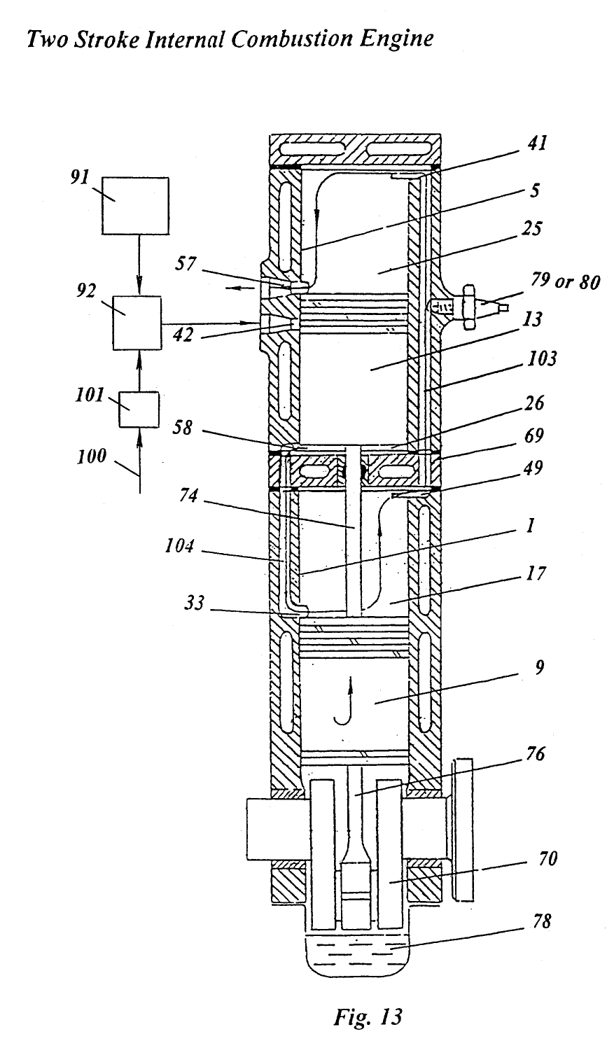

TSICE, shown on FIG. 13, is a single-row double-bank engine with two pistons 9 and 13, connected to each other with the piston rod 74, connected to the crank 70 by the connecting rod 76 and reciprocally movable in the cylinders 1 and 5, separated by the transverse partition 69. The cylinder 5 is double-sided whose power cavity 25 and pumping cavity 26 are connected to the power cavity 17 of cylinder 1 respectively by the channels 103 and 104. The channel 103 represents a common combustion chamber for the cavities 17 and 25, where air-fuel mixture is ignited by the spark plug 79. Since one pumping cavity is used for the charging of two power cavities, the intake port 42 of the pumping cavity 26 is connected to the external supercharger.

The method of operation of the TSICE on FIG. 13 is as follows.

At the end of power stroke, as it is shown on FIG. 13, both pistons 9 and 13 are at BDC. Fresh portion of air-fuel mixture, compressed in the cavity 26 during the power stroke, enters the cavity 17 through the open intake port 33, providing direct-flow scavenging/charging of cavities 17 and 25 through the channel 103, with the escape of burned gases through the exhaust port 57. The pistons 9 and 13, moving towards TDC, compress air-fuel mixture in the cavities 17 and 25 and at the same time create a vacuum in the cavity 26. When the pistons reach TDC, the intake port 42 opens and cavity 26 is charged with another fresh portion of air-fuel mixture by joint action of the supercharger 91 and the inside vacuum. At the same time, the ignition of compressed air-fuel mixture in the cavities 17 and 25 starts a power stroke, when the pistons go down until they reach BDC, and the process continues, as described above.

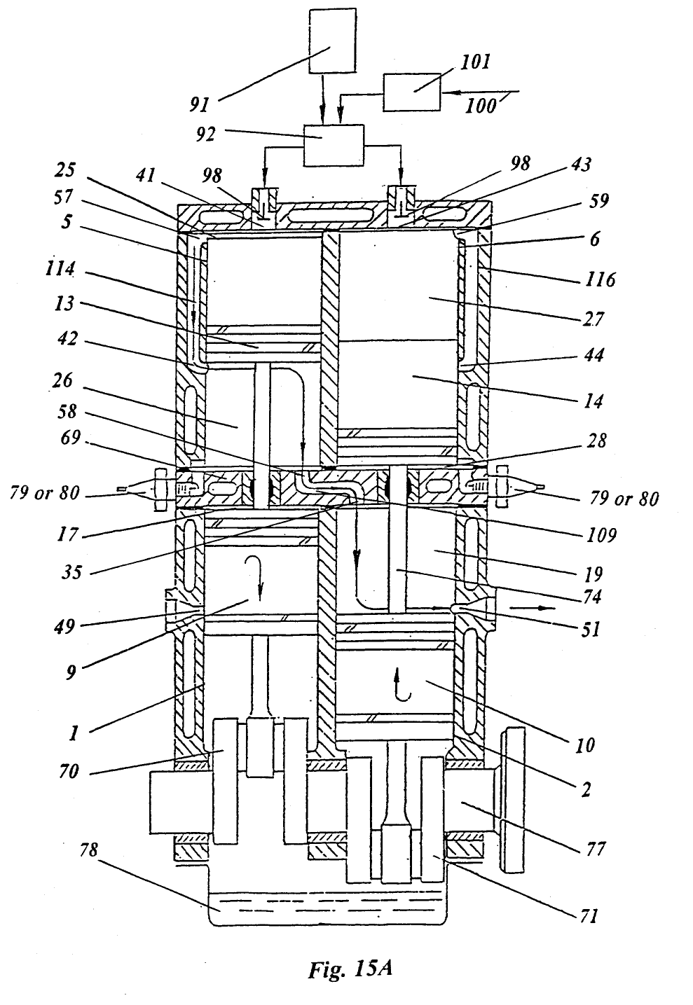

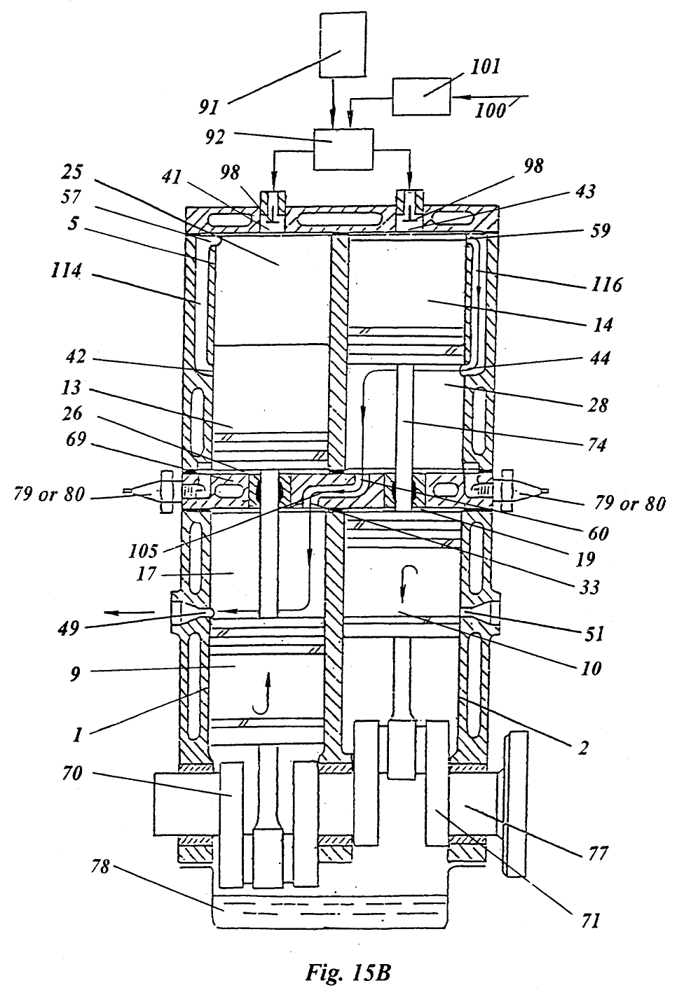

FIGS. 15A and 15B is a double-row double-bank TSICE with double-sided cylinders in the second bank. The pistons 9 and 13, reciprocally movable in the cylinders 1 and 5, are connected to the crank 70. The pistons 10 and 14, reciprocally movable in the cylinders 2 and 6, are connected to the crank 71. The cranks 70 and 71 have 180° angular deviation from each other, enabling motion of the pistons of the first and second rows in phase opposition. The cavities 19 and 26 are power cavities, connected to each other by the channel 109, shown on FIG. 15A and representing their common combustion chamber. The cavities 19 and 26 have the common spark plug 79, common intake port 42, located in the cavity 26, and the common exhaust port 51, located in the cavity 19. The cavities 17 and 28 are also power cavities, connected to each other by the channel 105, shown on FIG. 15B and representing their common combustion chamber. The cavities 17 and 28 have the common spark plug 79, common intake port 44, located in the cavity 28, and the common exhaust port 49, located in the cavity 17. The cavities 25 and 27 are pumping cavities. They have individual intake ports 41 and 43 and exhaust ports 57 and 59, connected to the intake ports 42 and 44 of power cavities by the channels 114 and 116. Since two pumping cavities are used for charging of four power cavities, the supercharger 91 is connected to the intake ports 41 and 43 of pumping cavities through self-acting suction valves 98.

The method of operation of the TSICE on FIGS. 15A and 15B is as follows. At the end of a power stroke, as it is shown on FIG. 15A, the pistons 9 and 13 are at TDC and the pistons 10 and 14 are at BDC. The pumping cavity 27 is charged with fresh portion of air-fuel mixture. The intake port 42 and the exhaust port 51 are open, and direct-flow scavenging/charging of the power cavities 26 and 19 goes on. Compressed in the pumping cavity 25 air-fuel mixture is released through the channel 114 into the cavity 26 and from there through the channel 109 into the cavity 19, pushing the rest of the burned gases out of the exhaust port 51. At the same time, the ignition of air-fuel mixture, compressed in the power cavities 17 and 28, initiates in them a power stroke, moving the pistons of the first and second row towards each other. The process of scavenging/charging of the cavities 19 and 26 ends, when the ports 42 and 51 close. With further move of the pistons 9 and 13 towards BDC and the pistons 10 and 14 towards TDC, the air-fuel mixture is compressed in the cavities 19 and 26, another portion of air-fuel mixture is compressed in the pumping cavity 27, and the pumping cavity 25 is filled with yet another portion of pressurized air-fuel mixture through the valve 98 and the intake port 41. When the pistons 9 and 13 reach BDC and the pistons 10 and 14 simultaneously reach TDC, as shown on FIG. 15B, the intake port 44 and the exhaust port 49 open and scavenging/charging of the power cavities 28 and 17 takes place. Compressed in the pumping cavity 27 air-fuel mixture is released through the channel 116 into the cavity 28 and from there, through the channel 105 into the cavity 17, pushing the rest of the burned gases out of the exhaust port 49. At the same time, the ignition of air-fuel mixture, compressed in the power cavities 19 and 26, initiates in them a power stroke, moving the pistons of the first and second row towards each other. The process of scavenging/charging of the cavities 17 and 28 ends, when the ports 44 and 49 close. With further move of the pistons 9 and 13 towards TDC and the pistons 10 and 14 towards BDC, air-fuel mixture is compressed in the cavities 17 and 28, another portion of air-fuel mixture is compressed in the pumping cavity 25, and the cavity 27 is filled up with yet another portion of pressurized air-fuel mixture through the valve 98 and the intake port 43. After pistons of the first and second rows reach respectively TDC and BDC, the process continues, as described above.

An advantage of this version of the TSICE is that the phase opposition of the cranks 70 and 71 balances the forces applied to the crankshaft bearings and reduces counterweights and inertial masses of the engine.

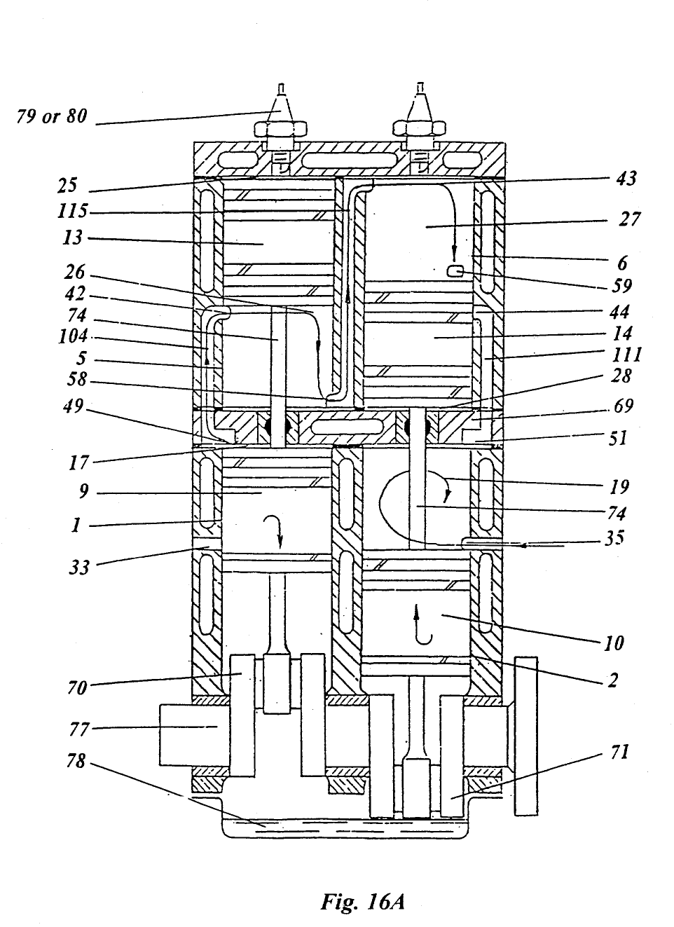

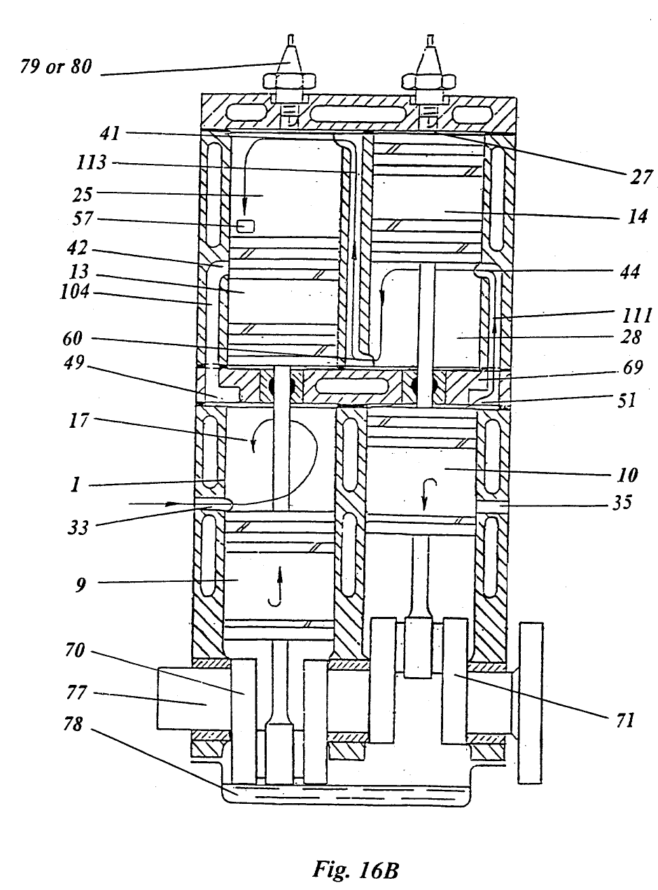

TSICE, shown on FIGS. 16A and 16B, as the previous version of TSICE, also has pistons of the first and second rows in phase opposition, with the difference in location of power and pumping cavities and connecting channels. It has the same method of operation, providing, that the cavities 25 . . . 28 are power cavities and the cavities 17 and 19 are pumping cavities.

The pistons 9 and 13, reciprocally movable in the cylinders 1 and 5, are connected to the crank 70. The pistons 10 and 14, reciprocally movable in the cylinders 2 and 6, are connected to the crank 71. The cranks 70 and 71 have 180° angular deviation from each other, enabling motion of the pistons of the first and second rows in phase opposition. The cavities 26 and 27 are power cavities, connected to each other by the channel 115, shown on FIG. 16A and representing their common combustion chamber. The cavities 26 and 27 have the common spark plug 79, common intake port 42, located in the cavity 26, and the common exhaust port 59, located in the cavity 27. The cavities 25 and 28 are also power cavities, connected to each other by the channel 113, shown on FIG. 16B and representing their common combustion chamber. The cavities 25 and 28 have the common spark plug 79, common intake port 44, located in the cavity 28, and the common exhaust port 57, located in the cavity 25. The cavities 17 and 19 are pumping cavities. They have individual intake ports 33 and 35 and exhaust ports 49 and 51, connected to the intake ports 42 and 44 of power cavities by the channels 104 and 111. Since two pumping cavities are used for charging of four power cavities, the intake ports 33 and 35 of pumping cavities are connected to a supercharger (not shown on FIG. 16).

The method of operation of the TSICE on FIGS. 16A and 16B is as follows. At the end of a power stroke, as it is shown on FIG. 15A, the pistons 9 and 13 are at TDC and the pistons 10 and 14 are at BDC. The pumping cavity 19 is charged with fresh portion of air-fuel mixture. The intake port 42 and the exhaust port 59 are open, and direct-flow scavenging/charging of the power cavities 26 and 27 goes on. Compressed in the pumping cavity 17 air-fuel mixture is released through the channel 104 into the cavity 26 and from there through the channel 115 into the cavity 27, pushing the rest of the burned gases out of the exhaust port 59. At the same time, the ignition of air-fuel mixture, compressed in the power cavities 25 and 28, initiates in them a power stroke, moving the pistons of the first and second row towards each other. The process of scavenging/charging of the cavities 26 and 27 ends, when the ports 42 and 59 close. With further move of the pistons 9 and 13 towards BDC and the pistons 10 and 14 towards TDC, the air-fuel mixture is compressed in the cavities 26 and 27, another portion of air-fuel mixture is compressed in the pumping cavity 19, and the pumping cavity 17 is filled with yet another portion of pressurized air-fuel mixture through the intake port 33. When the pistons 9 and 13 reach BDC and the pistons 10 and 14 simultaneously reach TDC, as shown on FIG. 16B, the intake port 44 and the exhaust port 57 open and scavenging/charging of the power cavities 28 and 25 takes place. Compressed in the pumping cavity 19 air-fuel mixture is released through the channel 111 into the cavity 28 and from there, through the channel 113 into the cavity 25, pushing the rest of the burned gases out of the exhaust port 57. At the same time, the ignition of air-fuel mixture, compressed in the power cavities 26 and 27, initiates in them a power stroke, moving the pistons of the first and second row towards each other. The process of scavenging/charging of the cavities 25 and 28 ends, when the ports 44 and 57 close. With further move of the pistons 9 and 13 towards TDC and the pistons 10 and 14 towards BDC, air-fuel mixture is compressed in the cavities 25 and 28, another portion of air-fuel mixture is compressed in the pumping cavity 17, and the cavity 19 is filled up with new portion of pressurized air-fuel mixture through the intake port 35. After pistons of the first and second rows reach respectively TDC and BDC (FIG. 16A), the process continues, as described above.

In comparison with the previous version of TSICE, shown on FIG. 15, engine on FIG. 16 has more preferable location of spark plugs and has no need in self-acting suction valves. Together those versions show the available variety of structural options.

All the engines, described above, achieve the object of increasing of power per liter of displacement.

The few shown examples of present invention can be used in a wide variety of applications, from small appliances, to the huge diesel marine engines.

Many more modifications of the present invention are possible, and among those, described above, TSICE, presented on FIG. 16, is considered as the preferred embodiment. Nevertheless, other shown embodiments may be given preference in different applications.

The scope of the invention should be determined by the appended claims, rather than by the examples given.

We claim:

1. A two stroke internal combustion engine, comprising a power cylinder with intake and exhaust ports and a source of scavenging, connected to the intake port of the power cylinder, with improvements, including engine being double-bank with allocation of cylinders on the top of one another, separated by transverse partition, piston of the first bank connected by rod to piston of the second bank, and said power cylinder having common combustion chamber with another power cylinder, located on the same or on the opposite side of the partition.
